(19) United States
(12) Patent Application Publication
(10) Pub. No.: US 2007/0022969 A1
(43) Pub. Date: Feb. 1, 2007

(54) Carrying case for small animals

(75) Inventors: Donald E. Godshaw, Evanston, IL (US); Andrezj M. Redzisz, Wheeling, IL (US)

Correspondence Address: BANNER & WITCOFF, LTD., TEN SOUTH WACKER DRIVE, SUITE 3000, CHICAGO, IL, 60606, US

(73) Assignee: Travel Caddy, Inc. d/b/a Travelon, Des Plaines, IL (US)

(21) Appl. No.: 11/190,095

(22) Filed: Jul. 26, 2005

(51) Int. Cl. A01K 1/035

(52) U.S. Cl. 119/497

(57) ABSTRACT

A carrying case for small animals comprises an open top bag supported by a shoulder strap with a waist strap connected to projecting flaps extending from the opposite sides of the carrying case.

### BACKGROUND OF THE INVENTION

In a principal aspect the present invention relates to a carrying case for small animals, and more particularly, to a carrying case which is supported by an array of straps which enable an individual to support the carrying case from their shoulder at their waist so that the animal may be retained within the carrying case resting on the hip of an individual.

Often when walking small animals such as dogs and cats, it becomes necessary to carry the animal. This necessity may arise because the animal becomes exhausted as a result of the length of a walk. Alternatively, the animal may be accompanying an individual on a trip or vacation and may require transport through buildings and other areas where the animal typically would not be permitted. Thus, there has developed a need for a carrying case for small animals.

### SUMMARY OF THE INVENTION

Briefly, the present invention comprises a carrying case for small animals which includes a bag having a back side, a bottom side, a front side, opposite end sides, and an open top side. The back side is generally contoured and includes a first side edge, a spaced, generally vertical second side edge and an upwardly extending flap comprising the remainder of the back side. The construction further includes first and second flexible, lateral flaps extending respectively from the first and second side edges of the back side. The flaps are connected by an adjustable length waist strap which includes a buckle so that the strap may be disconnected from one of the flaps. Further, there is included a shoulder strap which extends from the top edge of the back side and connects with one of the side flaps. The back side is connected to the front side of the animal support bag by means of flexible, first and second spaced auxiliary straps which are also adjustable in length. A cover flap may be provided for the top side, though it is not typical. Pockets may be included on any one of the sides. The carrying case shoulder strap may be placed over the left or right shoulder of an individual. The waist strap retains the carrying case against one hip or the other of the individual. A small animal may be placed within the bag. The front side of the bag is supported by the auxiliary straps so that the bag will be oriented in a manner which provides adequate support for a small animal within the carrying case.

Thus, it is an object of the invention to provide an improved carrying case for small animals incorporating various arrays of straps so that the animal may be supported by the shoulder and about the waist of an individual.

It is another object of the invention to provide a carrying case for small animals wherein the construction is rugged, flexible, may be placed on either hip of an individual to carry a small animal, and which comfortably supports a small animal within a carrying case.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1A is an isometric view of the carrying case of the invention as positioned on the right hand hip of an individual;

FIG. 1B is an isometric view of the carrying case of the invention as positioned on the left hip of an individual;

FIG. 2 is a bottom plan view of the carrying case of the invention;

FIG. 3 is a back side elevation of the carrying case of the invention;

FIG. 4 is a front plan view of the carrying case of the invention; and

FIG. 5 is a left hand side view of the carrying case of the invention.

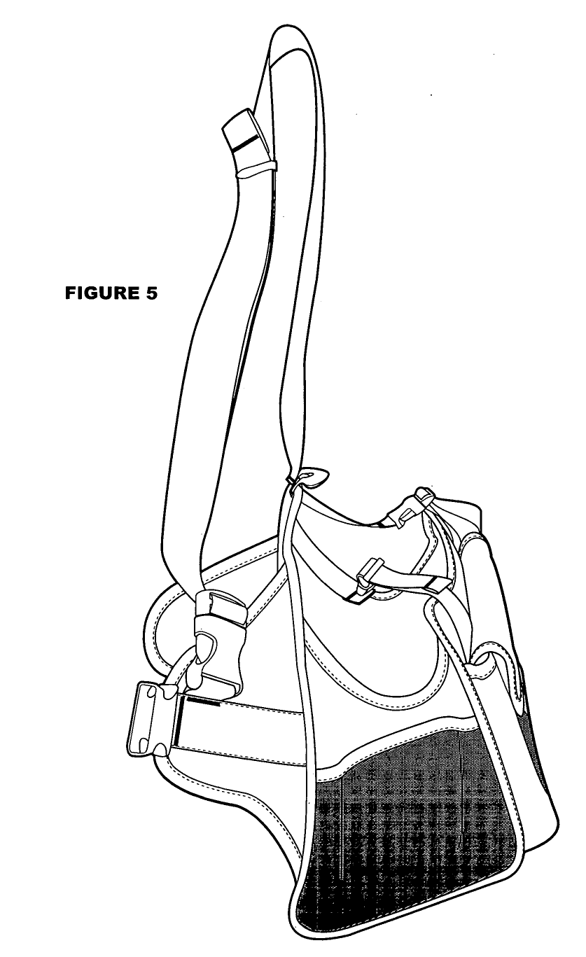

### DESCRIPTION OF THE PREFERRED EMBODIMENT

The carrying case of the invention is designed for carriage of small animals such as puppies, small dogs, cats and the like. Generally, the carrying case has the form of a rectangular parallelepiped case supported by straps that are attached to flaps extending from the back side of the case. The straps are typically adjustable in length and further typically include buckles so that they may be detached at least at one end from the carrying case.

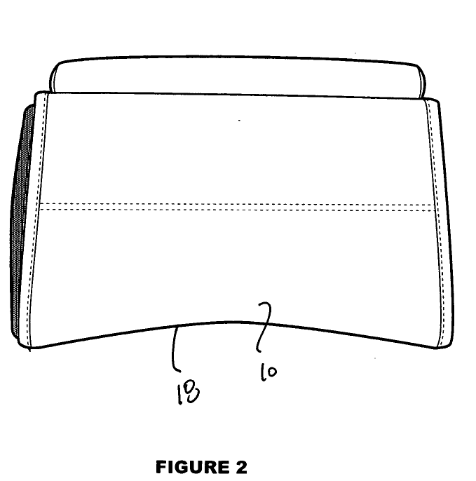

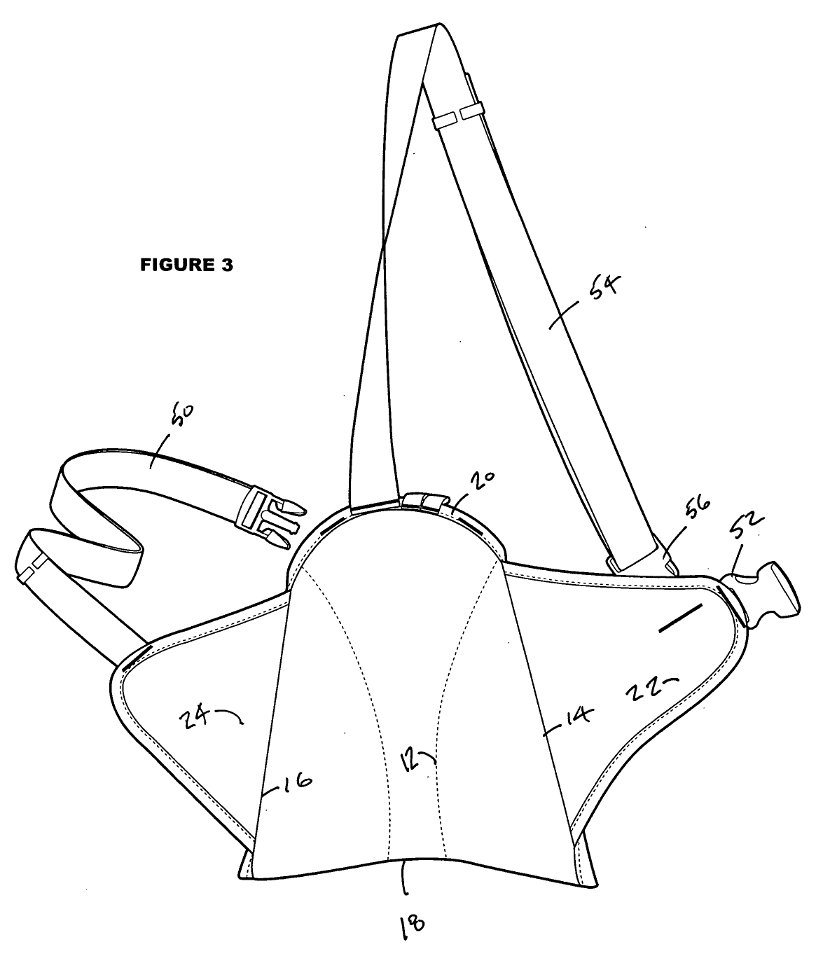

Thus, the carrying case includes a bottom side 10 as depicted in FIG. 2 and a back side 12 as depicted in FIG. 3. The back side 12 includes a first lateral side edge 14 which is generally vertical and a second lateral side edge 16 which is also generally vertical or alternatively which is inclined so as to extend upwardly and ultimately intersect with the first side edge 14. The back side 12 further includes a bottom edge 18 and arcuate top section and edge 20. A first generally triangular shaped flap 22 is comprised of a flexible material and is stitched and attached to the back side 12 along or at the first vertical side edge 14. A second generally triangular flap 24 is attached to the back side 12 along the second seam or side edge 16. The base of each of the flaps 22 and 24 extends generally between the bottom edge 18 upwardly for a distance less than about ⅔of the height of the back side 12. The bottom side 10 extends outwardly from the bottom side edge 18 and connects to a front side panel 30. An end panel or side 32 joins the front side panel 30 to the back side panel 12. Similarly, a second end panel or side 34 connects the front side panel 30 and back side panel 12. Of course, the bottom side 10 also joins the front side panel 30 and back side panel 12. Note that the back side panel 12 extends upwardly for a height exceeding the vertical height of the front side panel 30. An optional pocket with a flap 36 or pocket 35 may be attached and included on the front side panel 30. The ends 32 and 34 may be comprised of a mesh material or a fabric material.

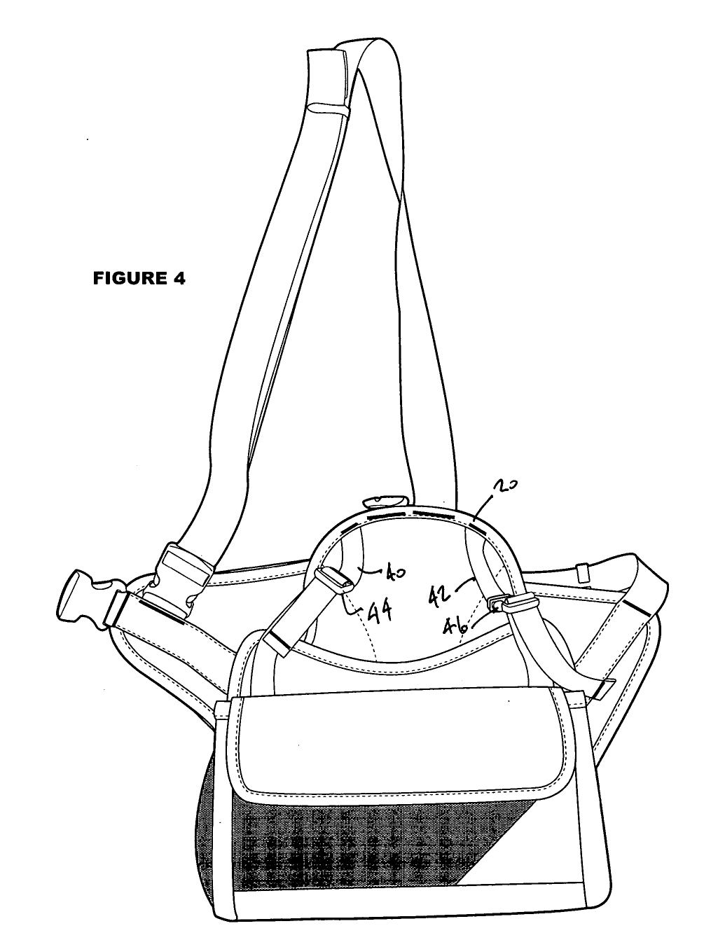

The top side edge 20 of the back side includes first and second spaced auxiliary straps 40 and 42 as depicted in FIG. 4. The auxiliary straps 40, 42 connect the top side edge 20 and the front panel 30. The straps 40 and 42 are adjustable in length and include buckles 44 and 46, respectively, so that the auxiliary straps 40 and 42 may be detached one from the other and thus expose the open top side of the bag comprising the carrying case.

An adjustable length waist strap 50 attaches the first flap 22 and second flap 24 and more particularly extends from the apex of each of the flaps 22 and 24 and may be connected by means of a buckle 52. The strap 50 comprises an adjustable waist strap. A shoulder strap 54 is also adjustable and connects from the top edge 20 to the buckle 56 attached to the outside end or apex of the first flap 22. Buckle 56 enables detachment of strap 54 from one of the flaps 54, 56.

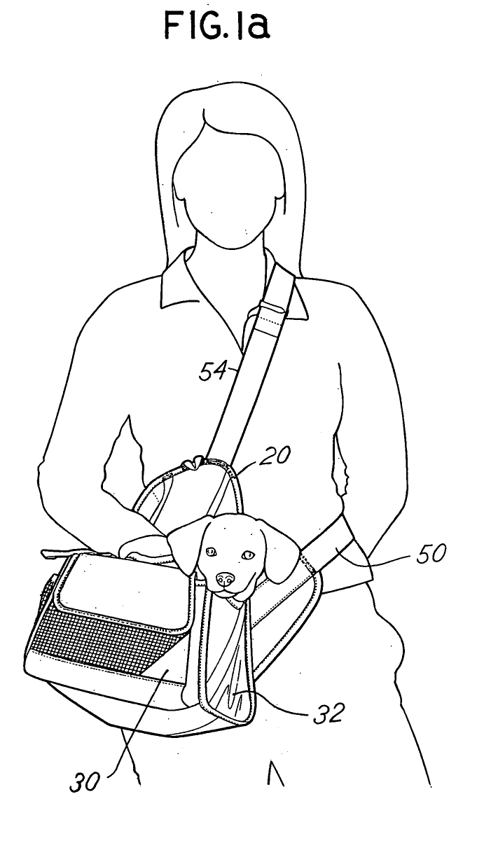

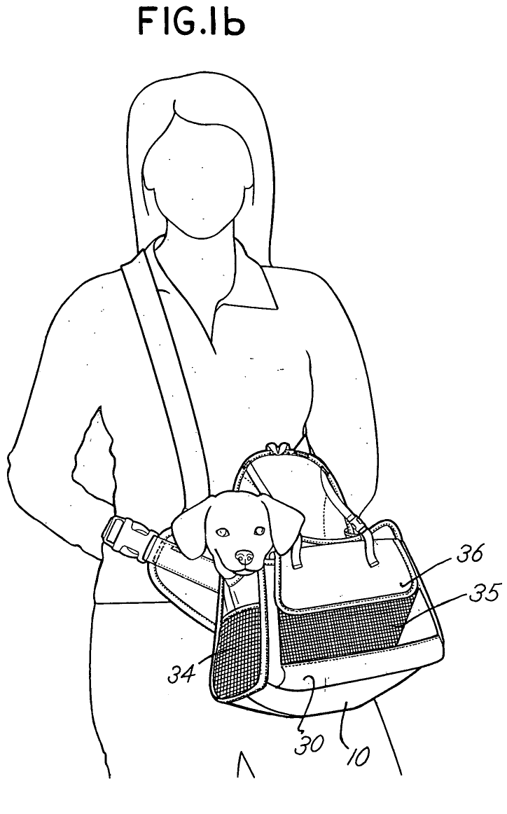

FIGS. 1A and 1B illustrate the manner of use of the carrying case. Thus, in order to place the carrying case on the right side of an individual, the shoulder strap 50 is placed over the left shoulder and the waist strap is placed around the waist of an individual. FIG. 1B illustrates the manner of placement of the component parts of the carrying case for left hip or left side placement. The carry strap 50 again is adjusted in length as is the waist strap. The shoulder strap is placed over the right shoulder and the bag is placed against the left hip with the waist strap 50 positioned around the waist of the individual.

In the preferred embodiment, the various component parts forming the carrying case are comprised of a fabric such as canvas, or other fabric materials which are generally flexible. The auxiliary straps 40 and 42 support the bottom side 10 generally canted upwardly by a slight angle to facilitate maintaining the small animal in an appropriate position within the bag. The straps 40, 42 also serve to restrain the small animal and keep the small animal within the bag. Pockets may be included at the ends and on the front panel. Various types of buckles and adjustable straps may be incorporated with the carrying case. Various other alternative features may be included. Thus, the invention is to be limited only by the following claims and equivalents thereof.

What is claimed is:

1. A carrying case for small animals comprising, in combination:
a bag with a back side, an open top side, a bottom support side, a first generally vertical side edge on one side of said back side, a second generally vertical side edge on the opposite side of said back side, a top edge on said back side;
a first flexible flap extending laterally from said first side seam,
a second flexible flap extending laterally from said second side seam in a direction generally opposite said first flexible flap, an adjustable length connecting strap extending between the first and second flaps, said adjustable length strap including a buckle for detaching the strap from one of said flaps, and an adjustable length shoulder strap connecting the top edge of the back side and the first flap, said adjustable length shoulder strap including a buckle for detaching the shoulder strap from the first flap.

2. The carrying case of claim 1 wherein the back side includes a bottom edge and wherein the bottom side is canted upwardly from the bottom edge of the back side.

3. The carrying case of claim 1 wherein the bag includes a front side and further including at least two spaced, auxiliary, adjustable length straps connecting the back side and the front side to thereby support the bag.

4. The carrying case of claim 4 wherein the auxiliary straps each include a buckle for detaching the auxiliary strap connection between the back side and the front side.
